(19) United States
(12) Patent Application Publication
(10) Pub. No.: US 2025/0286274 A1
(43) Pub. Date: Sep. 11, 2025

(54) LOCKING CAP ASSEMBLY FOR AN ANTENNA PORT AND RELATED METHODS OF INSTALLATION

(71) Applicant: Outdoor Wireless Networks LLC, Richardson, TX (US)

(72) Inventors: Maosheng Liu, Suzhou (CN); PuLiang Tang, Suzhou (CN)

(21) Appl. No.: 19/047,840

(22) Filed: Feb. 7, 2025

Related U.S. Application Data
(60) Provisional application No. 63/563,509, filed on Mar. 11, 2024.

(51) Int. Cl. H01Q 1/50

(52) U.S. Cl. CPC H01Q 1/50

(57) ABSTRACT

The present application is directed to a locking cap assembly for a radio frequency (RF) port of an antenna. The locking cap assembly includes a lockable end cap configured to engage with a threaded end of a connector of the RF port; and a protective sleeve configured to slide over the lockable end cap and engage a connector plate that secures the RF port to the antenna. Methods of installation and related antenna assemblies are also described herein.

### CROSS-REFERENCE TO RELATED APPLICATION(S)

This application claims priority to and the benefits of U.S. Provisional Application No. 63/563,509, filed on Mar. 11, 2024, the disclosure of which is incorporated herein by reference in its entirety.

### FIELD

The present invention relates to telecommunications equipment, and in particular, a locking cap assembly for a radio-frequency (RF) port for a small cell antenna and related methods of installation.

### BACKGROUND

In some instances, in order to quickly fulfill a small batch order of small cell type antennas, full frequency band model antennas may be reconfigured to accommodate the order request by reducing the number of available frequency bands. For example, a base model small cell antenna 10 (as shown in FIG. 1A) may be reconfigured reducing the total number of RF ports 20 (residing on a bottom end cap 12 of the antenna 10) by four (4) and changing the tilt from F2 to F4 (frequency bands) in order to form the target small cell antenna 10′ (as shown in FIG. 1B). As shown in FIG. 1B, four of the RF ports 20 have been removed and replaced with port plugs 16.

FIGS. 2A-2M illustrate exemplary steps taken to reconfigure the antenna 10 shown in FIG. 1A to form the antenna 10′ shown in FIG. 1B. As shown in FIGS. 2A-2C, fasteners 13 are removed which allows the radome 11 to be removed from the bottom end cap 12 of the antenna 10. As shown in FIGS. 2D-2H, selected RF ports 20 (e.g., Ports 17-20) including a connector 22 and removable end cap 24 are then removed from the bottom end cap 12 of the antenna 10. As shown in FIG. 2I, T2 tilt printed circuit boards (PCB) 15 are then replaced with T4 tilt PCB for all four faces of the antenna 10. As shown in FIG. 2K and FIG. 2L, the radome 11 is then secured back on the bottom end cap 12 of the antenna 10 (with fasteners 13) and the port plugs 16 are applied to cover the holes 20a for the respective RF ports 20 that have been removed from the bottom end cap 12. Finally, as shown in FIG. 2M, a new label 17 is attached to the bottom end cap 12 of the antenna 10, thereby completing the reconfiguration of the base model antenna 10 to the target antenna 10′.

### SUMMARY

A first aspect of the present invention is directed to a locking cap assembly for a radio frequency (RF) port of an antenna. The locking cap assembly includes a lockable end cap configured to engage with a threaded end of a connector of the RF port; and a protective sleeve configured to slide over the lockable end cap and engage a connector plate that secures the RF port to the antenna.

Another aspect of the present invention is directed to a method of reconfiguring accessible radio frequency ports of an antenna using a plurality of locking cap assemblies. Each radio frequency port includes a connector secured to a bottom end cap of the antenna by a connector plate, and each locking cap assembly includes a lockable end cap and a protective sleeve. The lockable end cap has an annular main body with a closed end that together define an interior cavity. The protective sleeve has a sleeve member coupled to a base, the sleeve member and base having a bore extending therethrough. The method includes (a) placing one of the lockable end caps onto an end of the connector of a selected radio frequency port; (b) rotating the lockable end cap to secure the lockable end cap onto the connector of the selected radio frequency port; (c) sliding the protective sleeve over the lockable end cap and onto the until the base contacts the bottom end cap of the antenna; and (d) repeating steps (a)-(c) until a desired number of radio frequency ports have a respective locking cap assembly secured thereon, thereby preventing access thereto.

Another aspect of the present invention is directed to an antenna assembly. The antenna assembly includes an end cap secured to a radome. The end cap includes a plurality of radio frequency ports extending outwardly therefrom. Each radio frequency port includes a connector and a connector plate. The antenna assembly further includes a locking cap assembly having a lockable end cap and a protective sleeve. The lockable end cap is engaged with a threaded end of the connector and the protective sleeve is slid over the lockable end cap and engaged with the connector plate, thereby preventing access to the respective radio frequency port.

Another aspect of the present invention is directed to an antenna assembly. The assembly includes an antenna including a plurality of first ports that are connected to transceiver cables and a second plurality of ports that are not connected to transceiver cables, and one or more blocking members mounted on the second plurality of ports that deny access to the second plurality of ports. The blocking members are configured to be removed by a user upon permission being received by the user.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a photograph of a bottom end cap of a known small cell antenna showing the RF ports extending outwardly therefrom.

FIG. 1B is a photograph of the bottom end cap of the small cell antenna of FIG. 1A after the antenna has been reconfigured (i.e., selected RF ports have been removed).

FIGS. 2A-2M illustrate exemplary steps taken to reconfigure the base antenna of FIG. 1A into the target antenna of FIG. 1B.

FIG. 3A is a bottom perspective view of an antenna assembly having locking cap assemblies installed on selected RF ports according to embodiments of the present invention.

FIG. 3B is an enlarged perspective view of a section of the bottom end cap of the antenna of FIG. 3A.

FIG. 4 is an enlarged view of a locking cap assembly for an antenna RF port according to embodiments of the present invention, with the protective sleeve illustrated as being transparent.

FIG. 5 is a perspective view of an exemplary locking tool that may be used to install/uninstall the locking cap assembly of FIG. 4 according to embodiments of the present invention.

FIG. 6A-6D illustrate exemplary steps taken to install the locking cap assembly of FIG. 4 on an antenna RF port according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components, or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

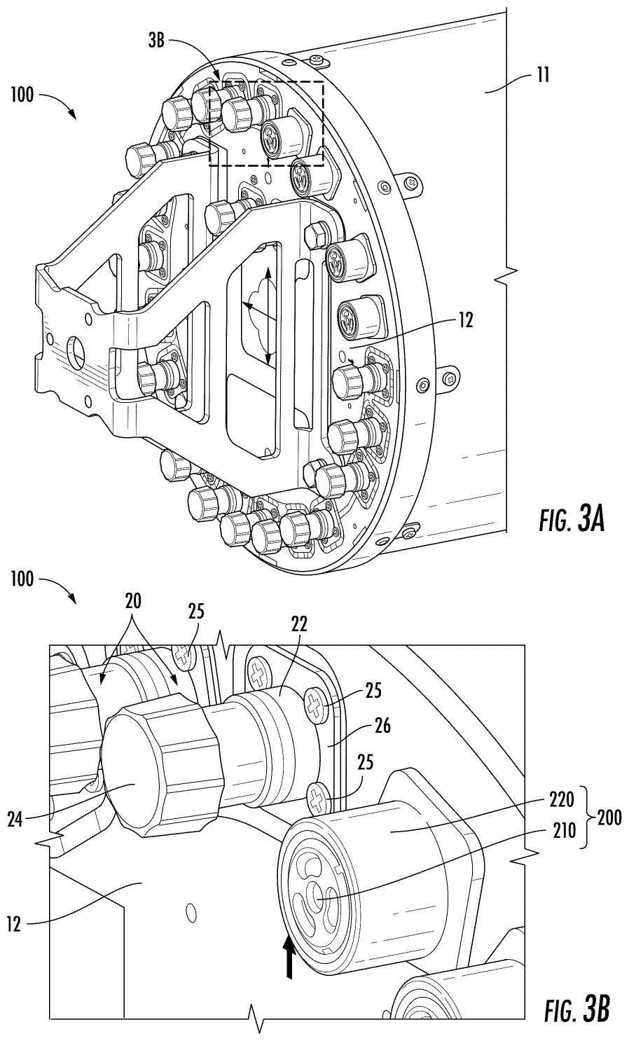

Embodiments of the present invention are directed to a locking cap assembly for an antenna RF port that may be used to prevent access to the respective port. The locking cap assemblies may be used to provide a quick way to reconfigure a base model antenna based on needs of the customer that is faster and easier than current processes. Embodiments of the present invention will now be described in further detail below with reference to FIGS. 3A-6D.

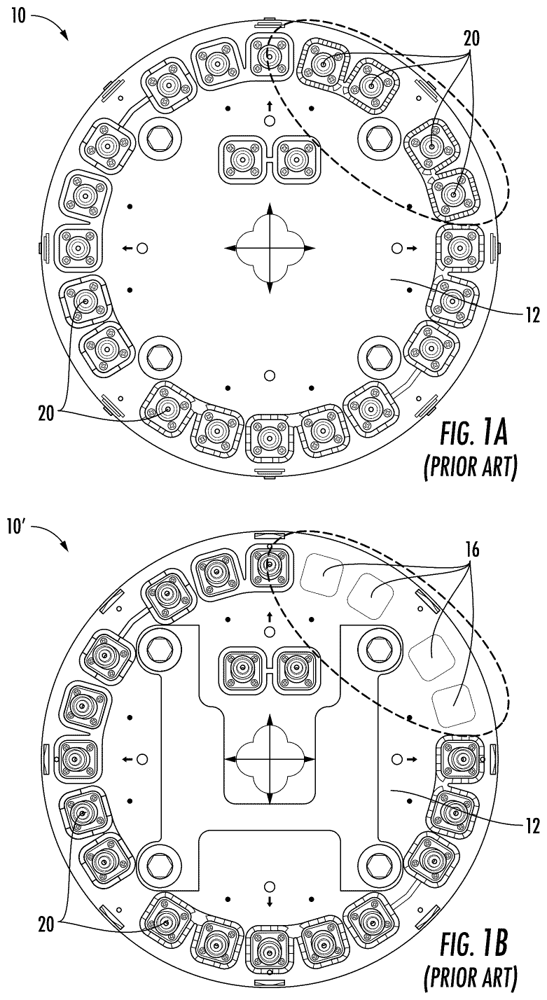

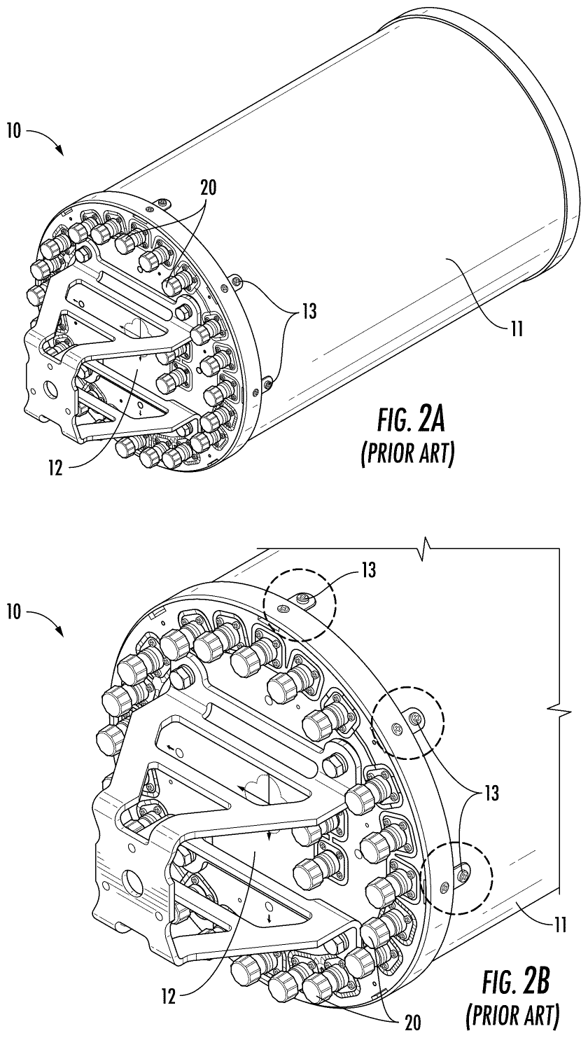

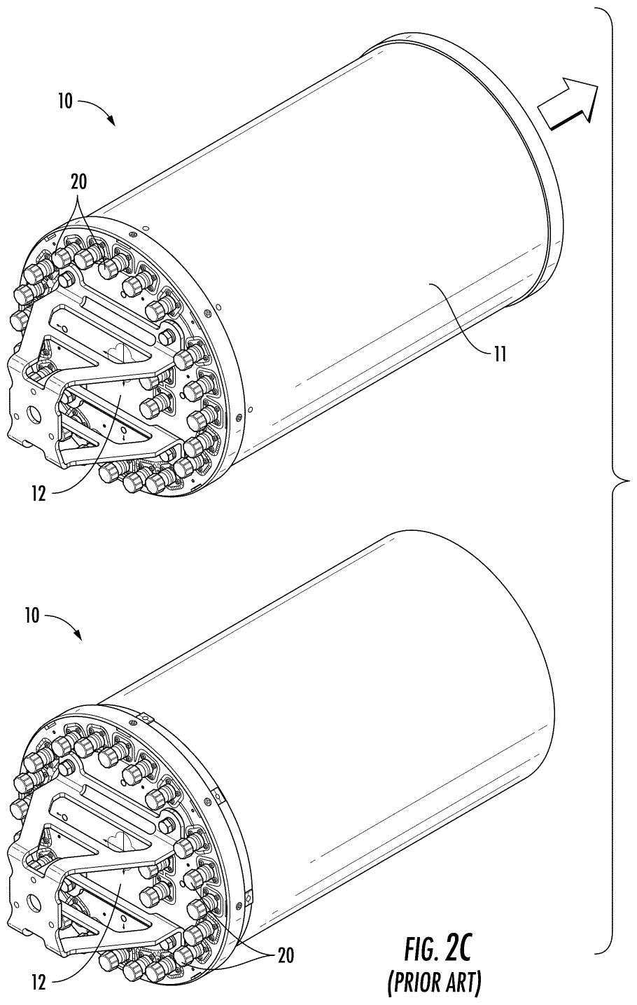

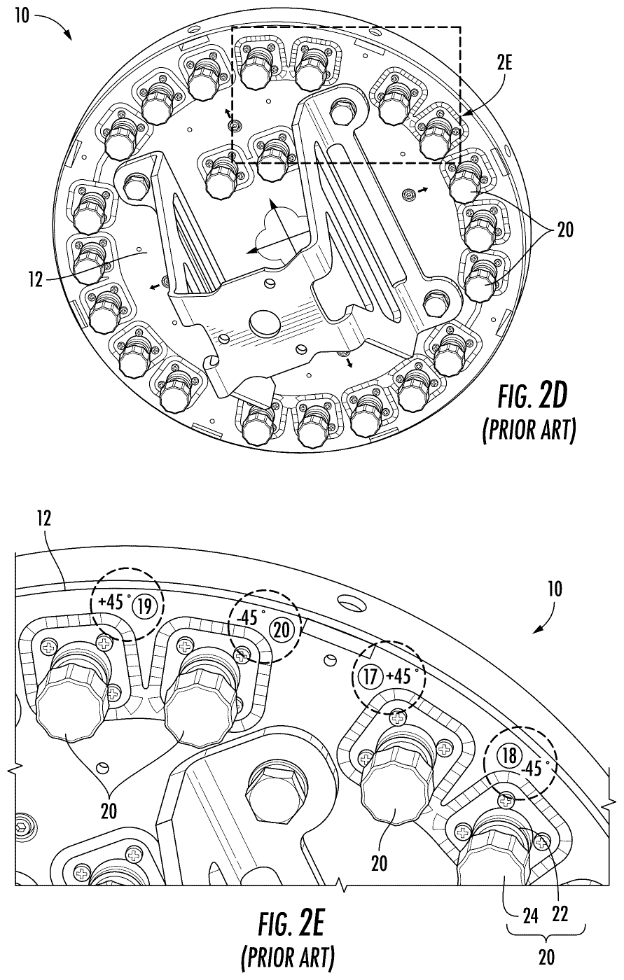

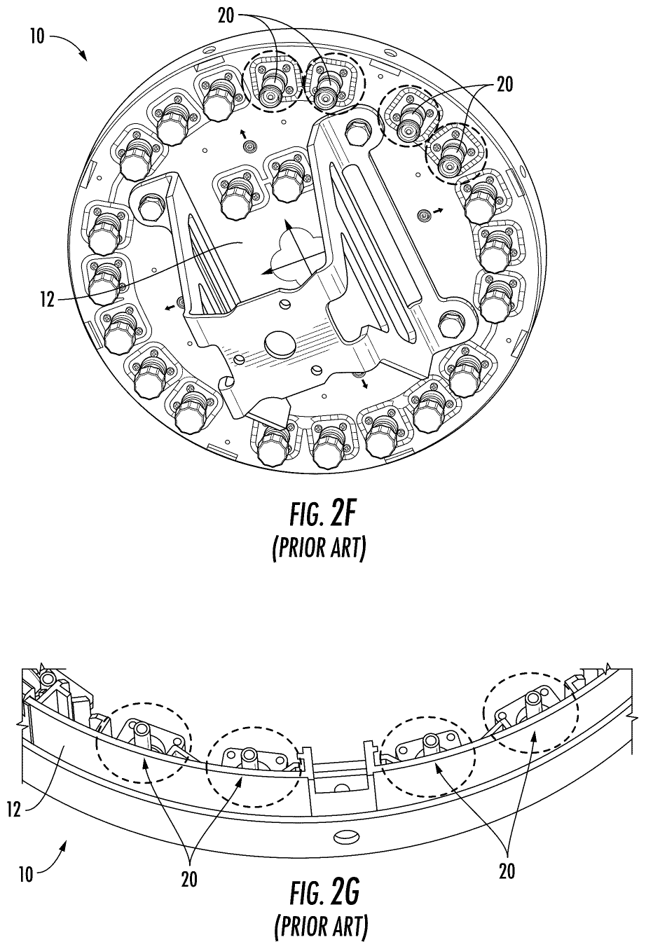

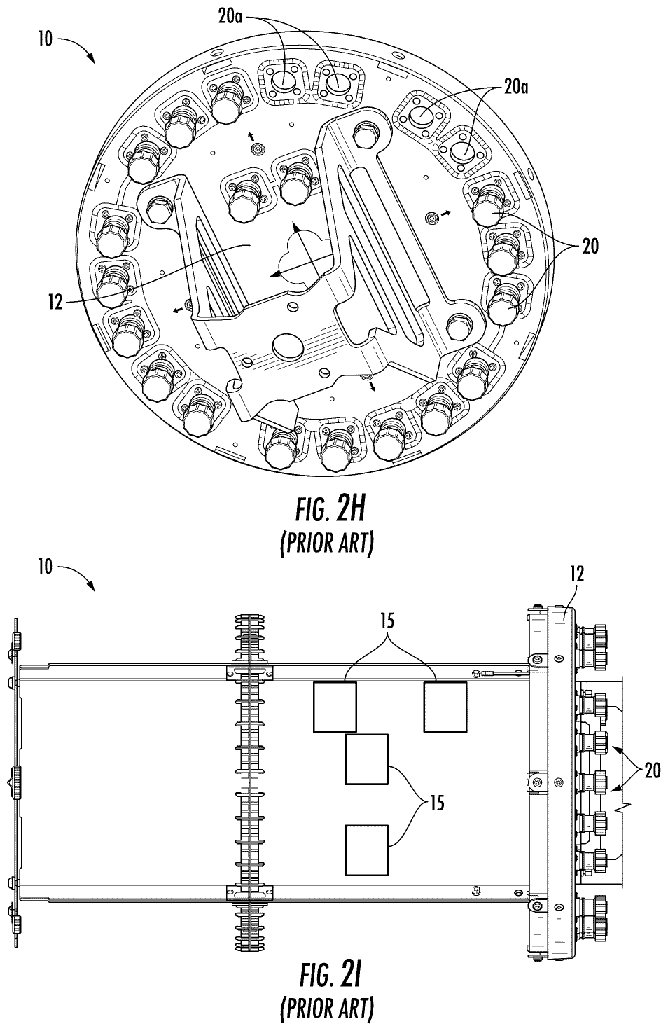

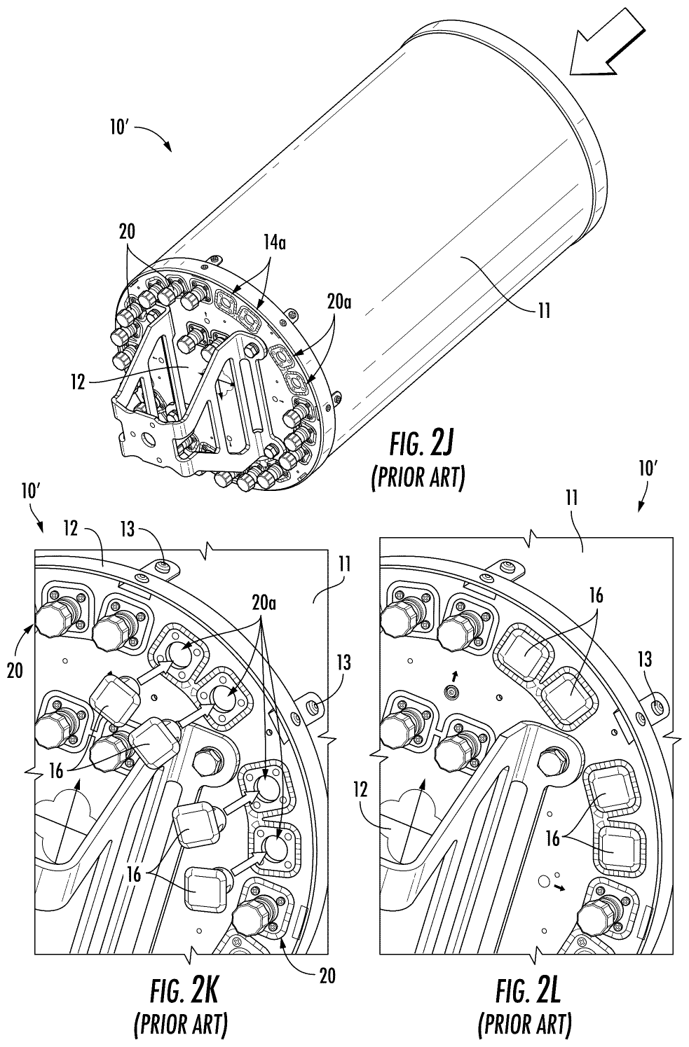

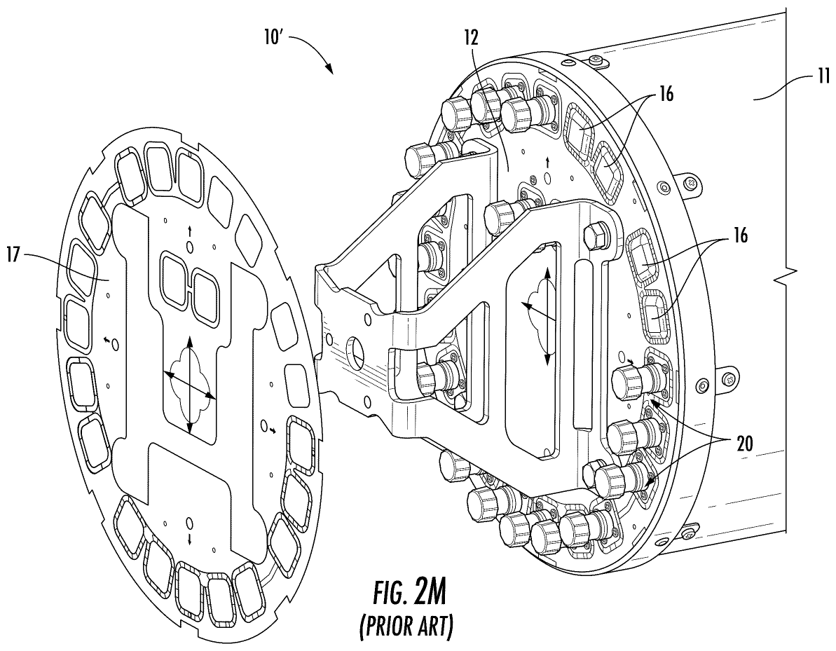

Referring to FIGS. 3A-3B, an antenna assembly 100 according to embodiments of the present invention is illustrated. The antenna assembly 100 is similar to the antenna 10′ described above and illustrated in FIG. 1B in that a selected number of RF ports 20 residing on the bottom end cap 12 of the assembly 100 are not currently being used. As shown in FIGS. 3A-3B, the antenna assembly 100 of the present invention differs from the antenna 10′ in that instead of removing RF ports 20 to reconfigure a base model antenna 10 to create the target antenna 10′ (as illustrated in FIGS. 2A-2M), each of the unused RF ports 20 for the antenna assembly 100 of the present invention are secured with a respective locking cap assembly 200, thereby preventing access of the respective RF port(s) 20 until needed.

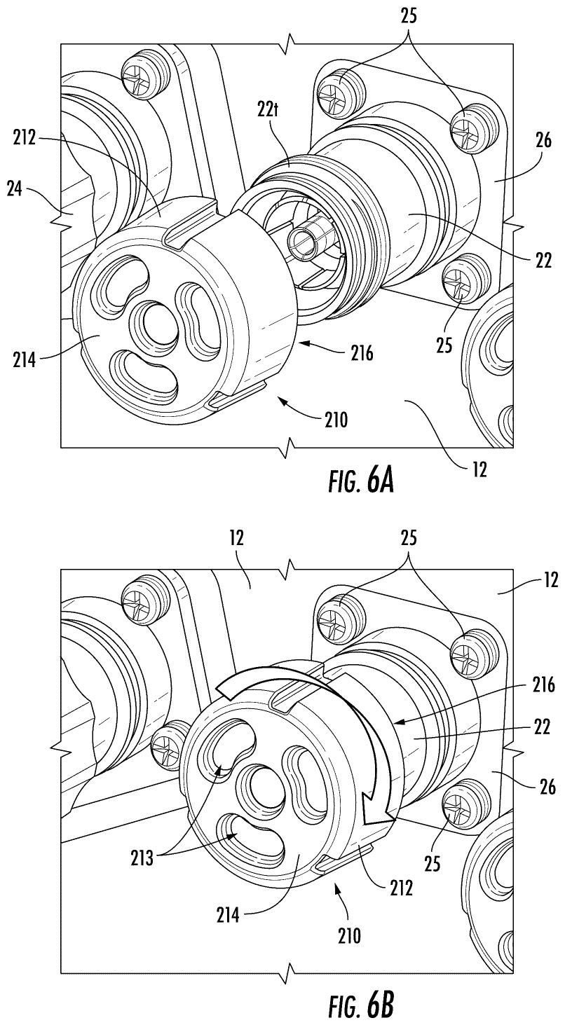

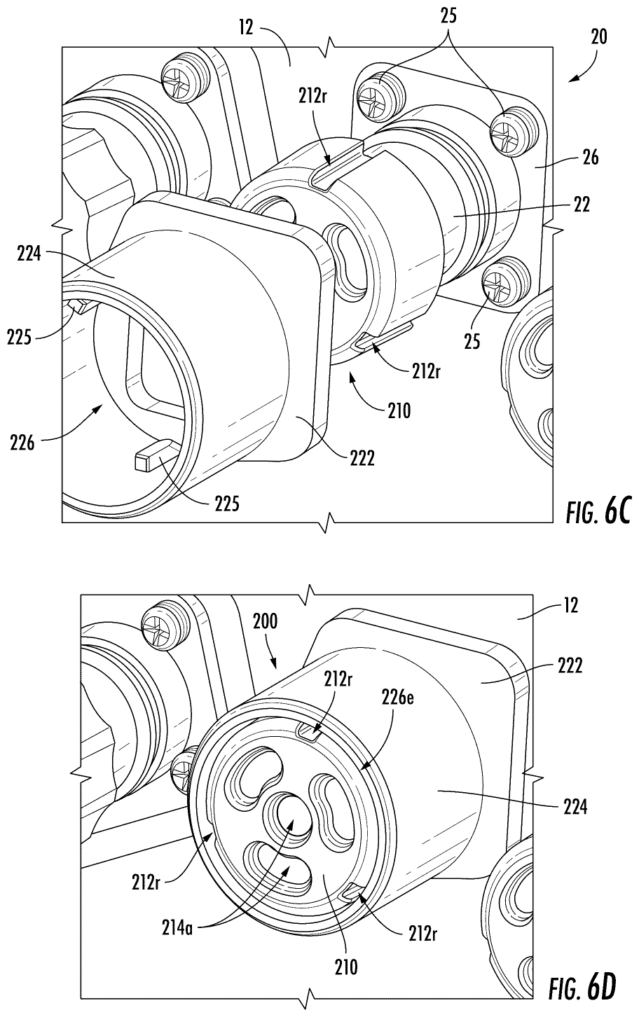

As shown in FIG. 3B, and as noted above, typically each RF port 20 of the antenna assembly 100 has a removable end cap 24 which helps to protect the corresponding connector 22 when the RF port 20 is not being used. In some instances, the removable end cap 24 may be secured to a threaded end 22t of the connector 22 (see also FIG. 6A). When a technician is ready to attach a cable to connector 22 of the respective RF port 20, the end cap 24 may be easily removed (e.g., unscrewed), thereby providing the technician uninhibited access to connector 22 to secure the cable.

In some instances, it may be desired to prevent access to selected RF ports 20. For example, it may be desirable to prevent a technician from attaching a cable to the wrong connector 22. As another example, it may be desirable to prevent the owner from having access to a particular port 20 (or group of ports) because that port is not part of the original usage agreement (i.e., access to the port is something the user pays for). In this instance, access to the port can be prevented until the user pays for use, at which time the supplier may provide a tool to enable the end caps 24 to be unlocked and removed. Therefore, to prevent access to selected RF port 20, the antenna assembly 100 of the present invention includes one or more locking cap assemblies 200. Each locking cap assembly 200 is configured to be installed over a selected RF port 20 (i.e., connector 22 and end cap 24). In some embodiments, the locking cap assemblies 200 may be configured such that a specific locking tool 250 (see, e.g., FIG. 5) may be required to remove each locking cap assembly 200 from an RF port 20 before the respective RF port 20 (i.e., connector 22) may be accessed (e.g., by a technician).

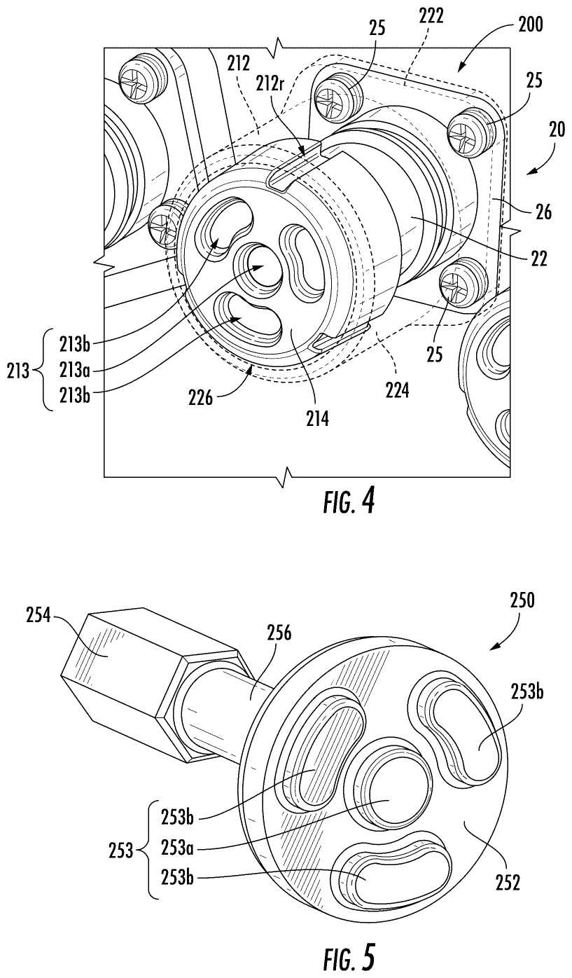

Still referring to FIG. 3B, in some embodiments, each locking cap assembly 200 may include a lockable end cap 210 and a protective sleeve 220. In some embodiments, the lockable end cap 210 is configured to engage the threaded end 22t of the connector 22 (see also FIG. 6A). In some embodiments, the protective sleeve 220 is configured to slide over the lockable end cap 210 in order to engage a connector plate 26 (see also FIG. 4). In some embodiments, the protective sleeve 220 may be sized and configured to encircle the connector 22 of the RF port 20, thereby helping to protect the connector 22 from environmental conditions (e.g., rain, moisture, etc.).

Referring to FIG. 4, in some embodiments, the lockable end cap 210 of the locking cap assembly 200 includes an annular main body 212 having a closed end 214. The main body 212 and closed end 214 together define an interior cavity 216 configured to receive at least a portion of the connector 22. In some embodiment, an inner surface of the main body 212 includes threads (not shown) that are configured to engage and mate with a threaded end 22t of the connector 22. In some embodiments, the lockable end cap 210 may further comprise one or more channels or recesses 212r extending axially along an outer surface of the main body 212. As described in further detail below, in some embodiments, the one or more channels 212r may be configured to receive a corresponding protrusion 225 of the protective sleeve 220 (see, e.g., FIG. 6C).

As further shown in FIG. 4, in some embodiments, an outer surface of the closed end 214 of the lockable end cap 210 includes a plurality of recesses 213. For example, as shown in FIG. 4, in some embodiments, the closed end 214 of the lockable end cap 210 comprises three oblong or “bean-shaped” recesses 213b extending circumferentially around a circular recess 213a. It is noted that embodiments of the present invention are not limited to the shapes, sizes, and/or positions of the recesses 213 illustrated in FIG. 4 and the plurality of recesses 213 may be formed in a variety of different shapes, sizes, and/or positions in the closed end 214 of the lockable end cap 210. As described in further detail below, each of the recesses 213 are configured to receive a respective corresponding protrusion 253a, 253b of a locking tool 250 (see also FIG. 5) in order to install/uninstall the lockable end cap 210 on the connector 22.

Still referring to FIG. 4, the protective sleeve 220 of the locking cap assembly 200 includes a base 222 and sleeve member 224 coupled to and extending outwardly from the base 222. The base 222 and sleeve member 224 have a bore 226 extending therethrough. The bore 226 is configured to receive the connector 22 and lockable end cap 210. In some embodiments, as shown in FIG. 4, the base 222 of the protective sleeve 220 may be sized and configured to fit over the connector plate 26 (and corresponding fasteners 25) that secures the connector 22 to the bottom end cap 12 of the antenna assembly 100. For example, as shown in FIG. 4, in some embodiments, the base 222 of the protective sleeve 220 has a generally square shape and the sleeve member 224 has a generally cylindrical shape (see also FIG. 6D). As shown in FIG. 6C, in some embodiments, an inner surface of the sleeve member 224 may comprise one or more protrusions 225 extending into the bore 226. As discussed above, in some embodiments, the number of protrusions 225 may correspond with the number of channels 212r in the lockable end cap 210. In some embodiments, the one or more protrusions 225 are configured to be received by respective channel 212r of the lockable end cap 210, for example, when the sleeve member 224 is being installed onto the RF port 20 (see FIG. 6C).

Referring now to FIG. 5, an exemplary locking tool (or tool attachment) 250 according to embodiments of the present invention is illustrated. As discussed above, the locking tool 250 may be used (required) to install/uninstall the lockable end cap 210 of the locking cap assembly 200 on the connector 22 of the RF port 20. As shown in FIG. 5, the locking tool 250 may comprise a head 252 and a base 254. In some embodiments, the locking tool 250 may further comprise a support member 256 that couples the head 252 to the base 254. In other embodiments, the head 252 may be directly coupled to the base 254. In some embodiments, the head 252 may have a circular shape. In some embodiments, the base 254 may have a hexagonal shape. In some embodiments, the base 254 of the tool 250 may be configured to be attached to a drill, screwdriver, or other like device.

As shown in FIG. 5, the head 252 of the tool 250 may comprise a plurality of protrusions 253. For example, as shown in FIG. 5, in some embodiments, the head 252 of the locking tool 250 comprises three oblong or “bean-shaped” protrusions 253b extending circumferentially around a circular protrusion 253a. Similar to the recesses 213 of the lockable end cap 210, it is noted that embodiments of the present invention are not limited to the shapes, sizes, and/or positions of the protrusions 253 illustrated in FIG. 5 and that the plurality of protrusions 253 may be formed in a variety of different shapes, sizes, and/or positions in head 252 of the locking tool 250. As described above, each of the protrusions 253a, 253b are configured to be received by respective a corresponding recess 213a, 213b of the lockable end cap 210 (FIG. 4) in order to install/uninstall the lockable end cap 210 on the connector 22.

Referring now to FIGS. 6A-6D, installation of the locking cap assembly 200 onto an RF port 20 of an antenna assembly 100 according to embodiments of the present invention is illustrated. As shown in FIGS. 6A-6B, the removable end cap 24 has been removed from the connector 22 and the lockable end cap 210 of the locking cap assembly 200 is placed on the threaded end 22t of the connector 22 (i.e., the threaded end 22t is received within the interior cavity 216 of the lockable end cap 210). As shown in FIG. 6B, the lockable end cap 210 is rotated (screwed) onto the connector 22. Next, as shown in FIG. 6C, the sleeve member 220 is slid over the lockable end cap 210 and onto the RF port 20 (i.e., the connector 22 is received through the bore 226). The protrusions 225 of the sleeve member 220 are received by, and slide through, corresponding channels 212r in the lockable end cap 210 as the sleeve member 200 is installed onto the RF port 20.

FIG. 6D shows the locking end assembly 200 installed on the RF port 20. As shown in FIG. 6D, when installed, the base 222 of sleeve member 220 fits over the connector plate 26 and respective fasteners 25. In some embodiments, the base 222 of the sleeve member 220 contacts the bottom end cap 12 of the antenna assembly 100. In some embodiments, when the locking end assembly 200 is installed on the RF port 20, the protrusions 225 are positioned within the respective channel 212r of the lockable end cap 210, thereby preventing rotation of the lockable end 210.

To uninstall the locking end assembly 200 from the RF port 20, the sleeve member 200 is slid off the RF port 20. A locking tool 250 having protrusions 253 that match the recesses 213 in the lockable end cap 210 may then be used to unscrew the lockable end cap 210 from the threaded end 22t of the connector 22, thereby enable use of the respective RF port 20.

Those of skill in this art will recognize that other variations for denying access to open ports may be suitable. For example, the locking tool and the recesses in which its protrusions are received may differ. The sleeve may take a different configuration. In some embodiments, the sleeves may be connected, such that they slip onto all four ports at once. Other configurations that enable the supplier to limit the user's access to certain ports until after the user has been granted permission (e.g., via payment of a fee or the like) may also be possible.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A locking cap assembly for a radio frequency (RF) port of an antenna, the locking cap assembly comprising:
a lockable end cap configured to engage with a threaded end of a connector of the RF port; and
a protective sleeve configured to slide over the lockable end cap and engage a connector plate that secures the RF port to the antenna.

2. The locking cap assembly according to claim 1, wherein the lockable end cap comprises an annular main body having a closed end, the main body and the closed end together define an interior cavity configured to receive at least a portion of the threaded end of the connector.

3. The locking cap assembly according to claim 2, wherein the lockable end cap further comprises one or more channels extending axially along an outer surface of the main body, the one or more channels configured to receive a corresponding protrusion of the protective sleeve.

4. The locking cap assembly according to claim 1, wherein an outer surface of the lockable end cap includes a plurality of recesses, each recess being configured to receive a corresponding protrusion of a locking tool used to install/uninstall the lockable end cap to/from the connector.

5. The locking cap assembly according to claim 4, wherein at least two of the plurality of recesses in the lockable end cap have a different shape and/or size.

6. The locking cap assembly according to claim 1, wherein the protective sleeve includes a base and a sleeve member coupled to and extending outwardly from the base.

7. The locking cap assembly according to claim 6, wherein the base and the sleeve member of the protective sleeve have a bore extending therethrough that is configured to receive the connector and lockable end cap, the base being configured fit on top of the connector plate.

8. The locking cap assembly according to claim 4, wherein the locking tool includes a head coupled to a base, the head comprising a plurality of corresponding protrusions.

9. A method of reconfiguring accessible radio frequency ports of an antenna using a plurality of locking cap assemblies, wherein each radio frequency port comprises a connector secured to a bottom end cap of the antenna by a connector plate, and wherein each locking cap assembly comprises a lockable end cap having an annular main body with a closed end that together define an interior cavity, and a protective sleeve having a sleeve member coupled to a base, the sleeve member and base having a bore extending therethrough, the method comprising:
(a) placing one of the lockable end caps onto an end of the connector of a selected radio frequency port;
(b) rotating the lockable end cap to secure the lockable end cap onto the connector of the selected radio frequency port;
(c) sliding the protective sleeve over the lockable end cap and onto the until the base contacts the bottom end cap of the antenna; and
(d) repeating steps (a)-(c) until a desired number of radio frequency ports have a respective locking cap assembly secured thereon, thereby preventing access thereto.

10. The method according to claim 9, wherein an outer surface of the lockable end cap has a plurality of channels and an inner surface of the sleeve member has a plurality of protrusions, the method further comprising:
positioning the protective sleeve such that each of the protrusions of the sleeve member aligns with and slides within a respective channel of the lockable end cap during step (c).

11. The method according to claim 9, wherein the closed head of the lockable end cap comprises a plurality of recesses, the methods further comprising:
using a locking tool to rotate the lockable end cap,
wherein the locking tool comprises a plurality of protrusions, each protrusion configured to be received by a respective recess in the lockable end cap.

12. The method according to claim 9, wherein the steps of the method are performed until four radio frequency ports of the antenna have a respective locking cap assembly secured thereon.

13. An antenna assembly, the antenna assembly comprising:
an end cap secured to a radome, the end cap comprising a plurality of radio frequency ports extending outwardly therefrom, each radio frequency port comprising a connector and a connector plate; and
a locking cap assembly comprising a lockable end cap and a protective sleeve,
wherein the lockable end cap is engaged with a threaded end of the connector and the protective sleeve is slid over the lockable end cap and engaged with the connector plate, thereby preventing access to the respective radio frequency port.

14. The antenna assembly according to claim 13, wherein the lockable end cap comprises an annular main body having a closed end, the main body and closed end define an interior cavity that receives at least a portion of the threaded end of the connector.

15. The antenna assembly according to claim 14, wherein the lockable end cap further comprises one or more channels extending axially along an outer surface of the main body, the one or more channels receives a corresponding protrusion of the protective sleeve.

16. The antenna assembly according to claim 13, wherein an outer surface of the lockable end cap includes a plurality of recesses, each recess being configured to receive a corresponding protrusion of a locking tool used to install/uninstall the lockable end cap to/from the connector.

17. The antenna assembly according to claim 16, wherein at least two of the plurality of recesses in the lockable end cap have a different shape and/or size.

18. The antenna assembly according to claim 13, wherein the protective sleeve includes a base and a sleeve member coupled to and extending outwardly from the base.

19. The antenna assembly according to claim 18, wherein the base and the sleeve member of the protective sleeve have a bore extending therethrough that is configured to receive the connector and lockable end cap, the base being configured fit on top of the connector plate.

20. The antenna assembly according to claim 16, wherein the locking tool includes a head coupled to a base, the head comprising a plurality of corresponding protrusions.

21. An antenna assembly, the antenna assembly comprising:
an antenna comprising a plurality of first ports that are connected to transceiver cables and a second plurality of ports that are not connected to transceiver cables; and
one or more blocking members mounted on the second plurality of ports that deny access to the second plurality of ports;
wherein the blocking members are configured to be removed by a user upon permission being received by the user.
